(19) United States
(12) Patent Application Publication
(10) Pub. No.: US 2010/0293766 A1
(43) Pub. Date: Nov. 25, 2010

(54) Tensioning Apparatus for Strap

(76) Inventor: Han-Ching Huang, Taichung (TW)

Correspondence Address: Dr. BANGER SHIA;Patent Office of Bang Shia, 102 Lindencrest Ct, Sugar Land, TX, 77479-5201, US

(21) Appl. No.: 12/512,118

(22) Filed: Jul. 30, 2009

Related U.S. Application Data
(63) Continuation-in-part of application No. 12/470,536, filed on May 22, 2009.

(51) Int. Cl. B25B 25/00

(52) U.S. Cl. 24/68 CD

(57) ABSTRACT

A tensioning apparatus includes a frame, a tensioning device mounted on a first end of the frame, and a reeling device mounted on a second end of the frame. The tensioning device includes a tensioning mechanism and a lever operably pivoted to rotate the tensioning mechanism, and a strap engaged with the tensioning device can be tensioned as the tensioning device is rotated. Additionally, the strap can be collected on the reeling device. Furthermore, the reeling device includes a ratcheting mechanism that facilitates collection of the strap by preventing the reeling device to turn in a direction that unreels the strap.

### CROSS REFERENCE

The present application is a continuation-in-part application of U.S. patent application Ser. No. 12/470,536, filed on May 22, 2009, of which the entire disclosure is incorporated herein.

### BACKGROUND OF THE INVENTION

1. Field of the Invention

The present invention relates to a tensioning apparatus for a strap.

2. Description of the Related Art

Referring to U.S. Pat. No. 7,296,326, a tensioning apparatus including a frame, a lever and a reeling device rotatably mounted between two sidewalls of the lever. The reeling device includes a shaft with a slot defined therein, and two knobs mounted on proximal and distal ends thereof respectively. User generally grips the shaft to operably move the lever. Further, user can insert the end of the strap through the slot and turn the knob to wind the strap on the shaft. A problem is that when the strap collected on the shaft would obstruct user to operate the lever. Another problem is that when turning the knob in a direction to wind the strap, it has sometimes happened that the knob is liable to turn in an opposite direction to unwind the strap.

The present invention is, therefore, intended to obviate or at least alleviate the problems encountered in the prior art.

### SUMMARY OF THE INVENTION

According to the present invention, a tensioning apparatus includes a frame, a tensioning mechanism rotatably mounted on a first end of the frame, and a lever connected with the tensioning mechanism and operably pivoted with respect to the frame to rotate the tensioning mechanism. The tensioning mechanism can tension a strap as it is rotated. The strap includes first and second portions extending in opposite directions of the tensioning mechanism. A reeling mechanism is rotatably mounted on a second end of the frame and is adapted to collect one of the first and second portions of the strap. Further, a ratcheting mechanism includes a ratchet member mounted on the shaft and rotated with the shaft, a pawl operably moveable between a first position in engagement with the ratchet member and a second position disengaged from the ratchet member, and an elastic element including a first leg mounted on the frame and a second end connected with the pawl for biasably engaging the pawl with the ratchet member.

It is an object of the present invention that the reeling device is used for collecting one of the first and second portions of the strap.

It is another object of the present invention that the strap on the reeling device will not obstruct the operation of the lever.

It is a further object of the present invention that the ratcheting mechanism facilitates collection of the second portion of the strap by preventing the shaft from turning in a direction to unreel the strap.

### BRIEF DESCRIPTION OF THE DRAWINGS

FIG. 1 is a perspective view of a tensioning apparatus in accordance with a first embodiment of the present invention.

FIG. 2 is a perspective view showing a strap collected on a reeling device embodying the present invention.

FIG. 3 is a partial, exploded perspective view of the reeling device embodying the present invention.

FIG. 4 is a perspective view showing the strap released from the reeling device embodying the present invention.

FIG. 5 is a schematic view showing the operation of the reeling device embodying the present invention.

FIG. 6 is a schematic view showing the strap collected on the reeling device embodying the present invention.

FIG. 7 is a side view showing a ratcheting mechanism embodying the present invention.

FIG. 8 is an enlarged view of the ratcheting mechanism shown in FIG. 7.

FIG. 9 is an extend view of FIG. 8 and shows a pawl biasably engaged with a ratchet member.

FIG. 10 is a schematic view show the pawl engaged in another position than that of the FIG. 8.

FIG. 11 is a schematic view showing that the pawl adapted to be retained and disengaged from the ratchet member.

FIG. 12 is a perspective view of a tensioning apparatus in accordance with a second embodiment of the present invention.

FIG. 13 is a side view of the tensioning apparatus shown in FIG. 12.

FIG. 14 is a perspective view of a tensioning apparatus in accordance with a third embodiment of the present invention.

FIG. 15 is an exploded perspective view of the tensioning apparatus shown in FIG. 14.

FIG. 16 is another perspective view of the tensioning apparatus shown in FIG. 14.

FIG. 17 is a perspective view of a tensioning apparatus in accordance with a fourth embodiment of the present invention.

FIG. 18 is an exploded perspective view of the tensioning apparatus shown in FIG. 17.

FIG. 19 is another perspective view of a tensioning apparatus shown in FIG. 17.

### DETAILED DESCRIPTION OF THE PREFERRED EMBODIMENT

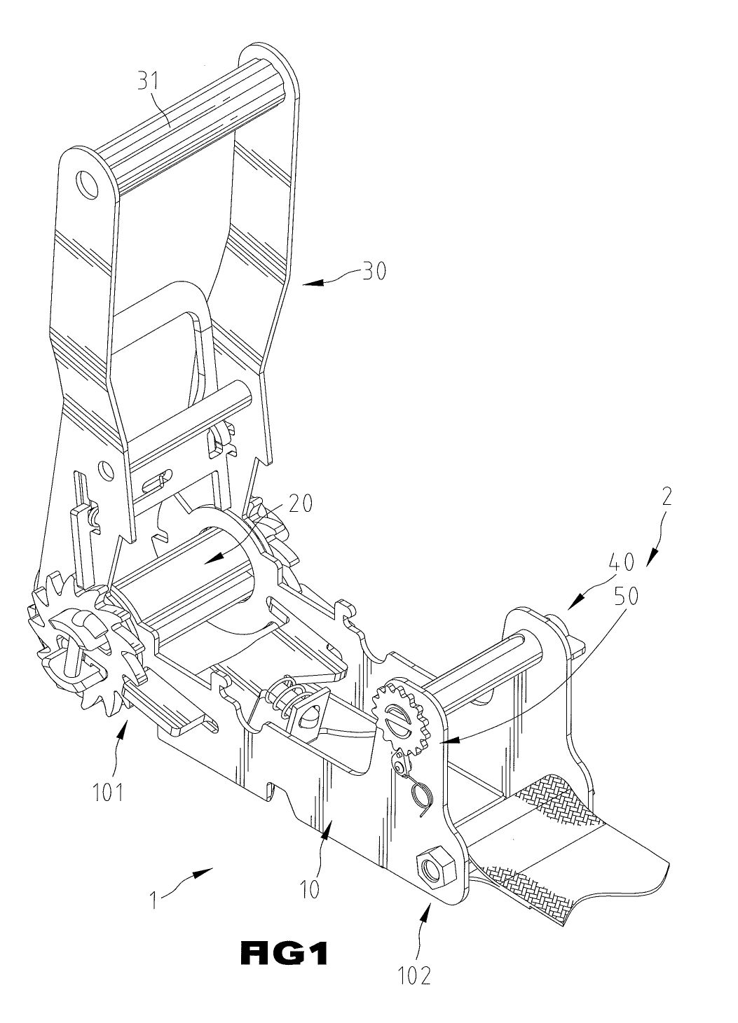

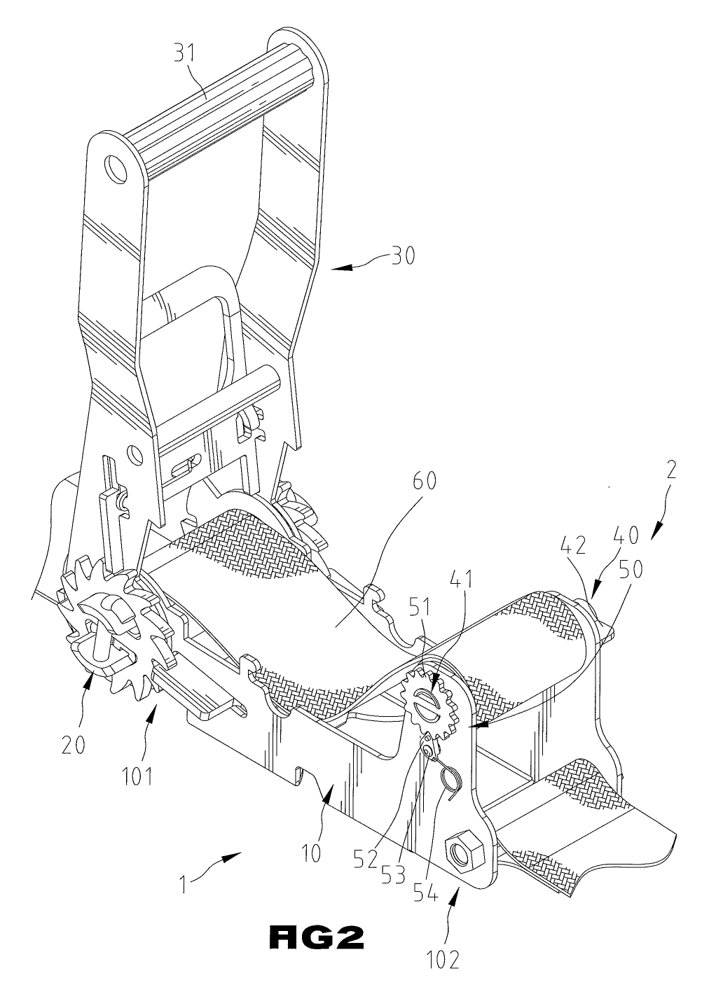

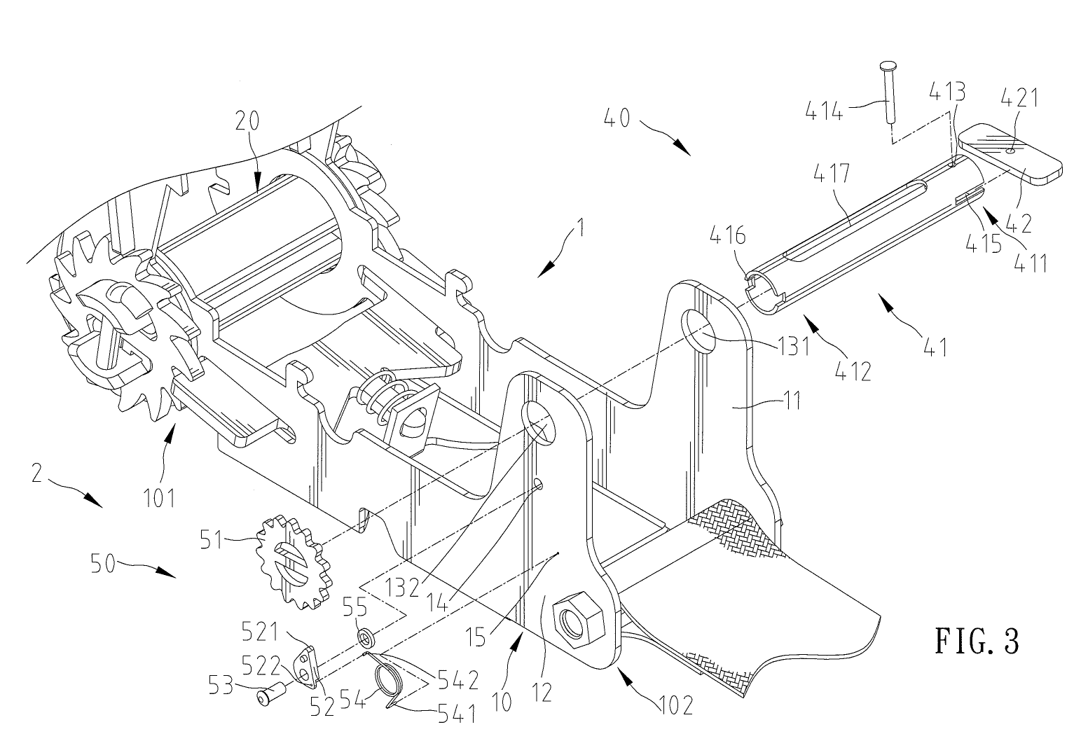

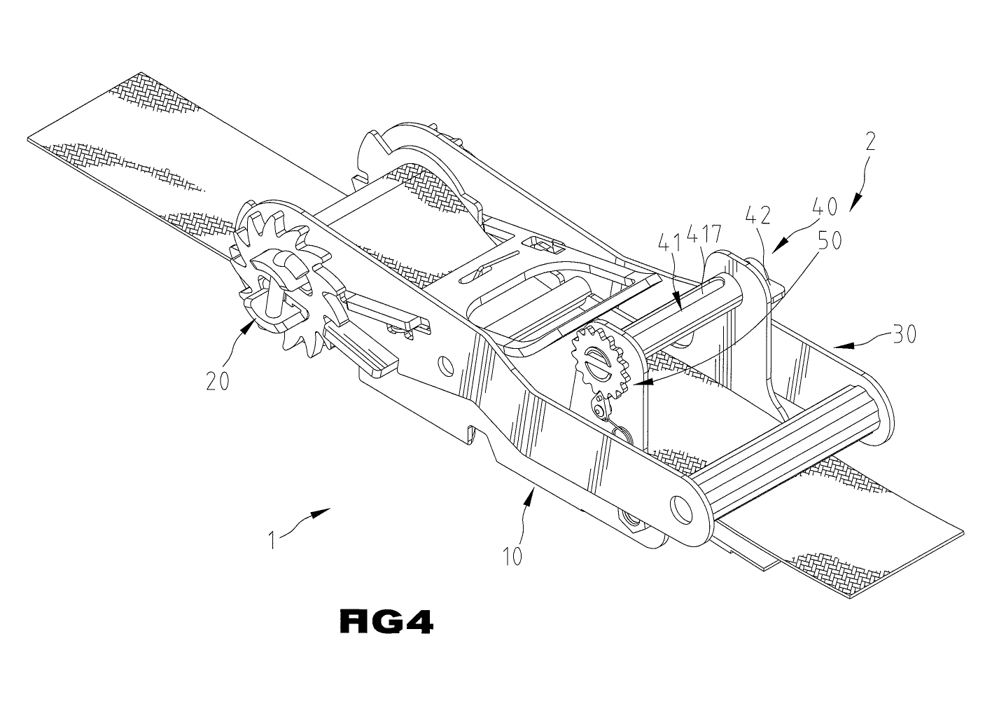

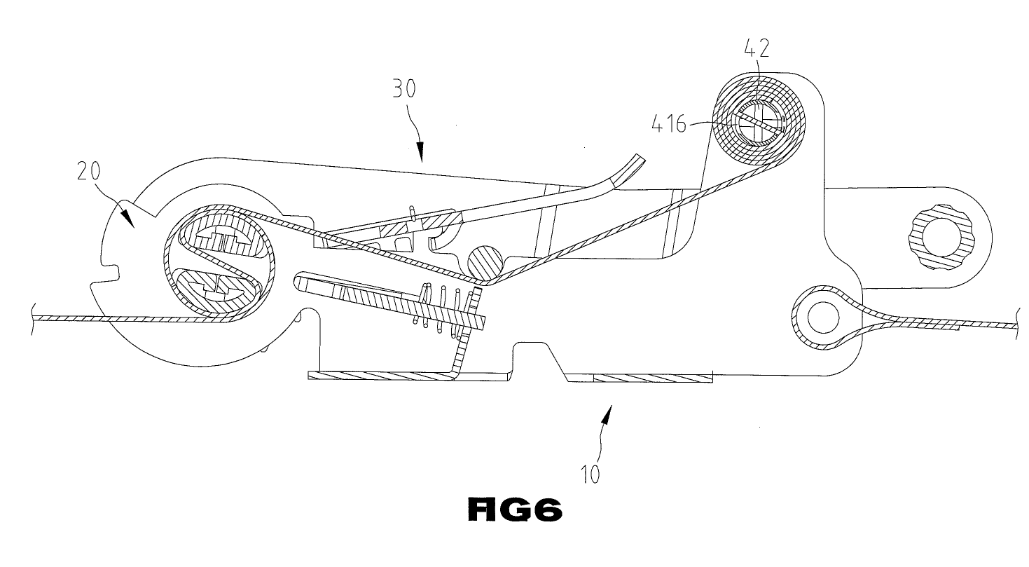

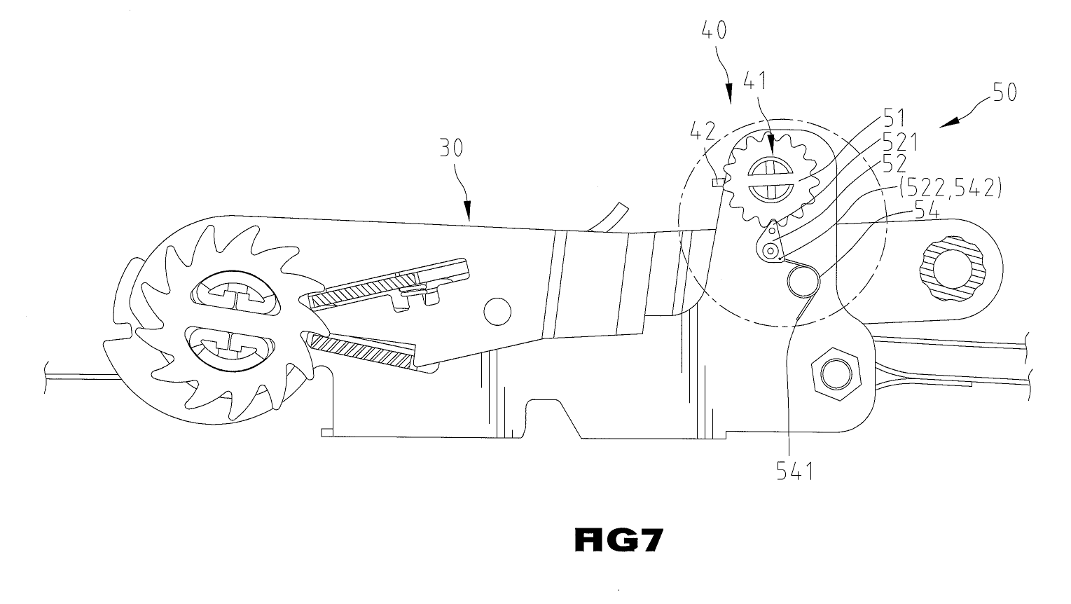

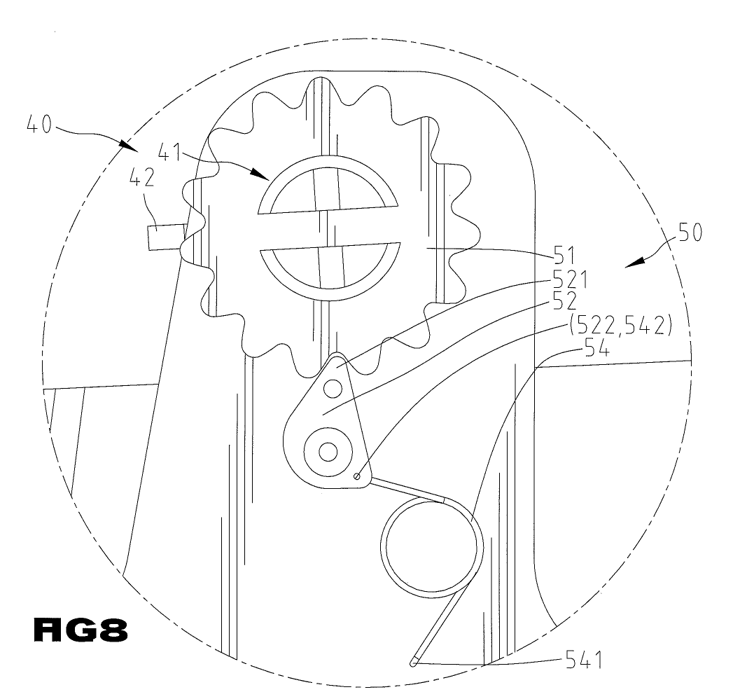

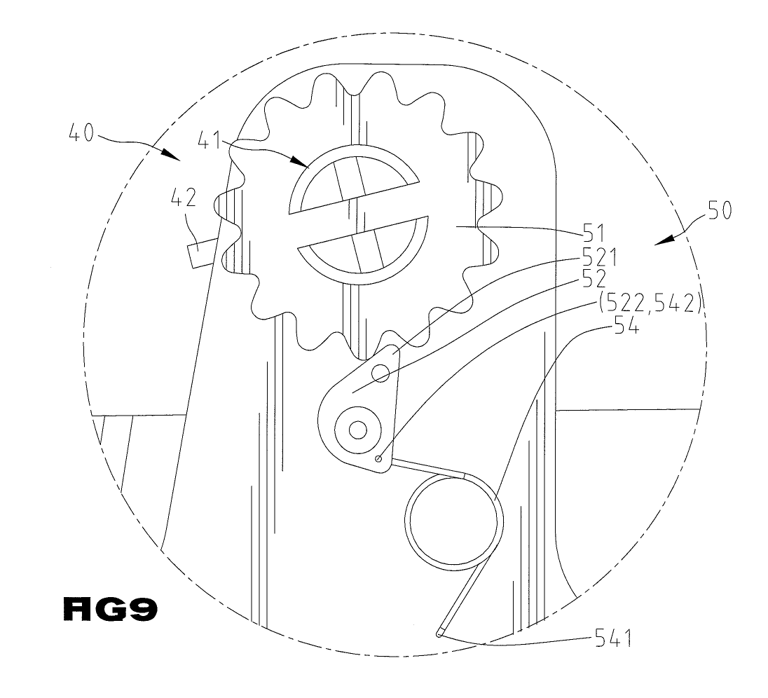

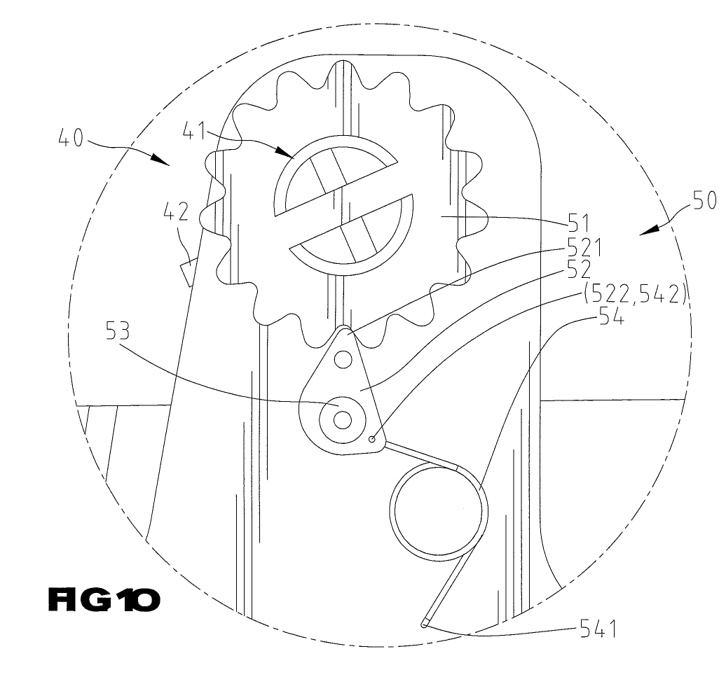

FIGS. 1 through 11 show a tensioning apparatus in accordance with a first embodiment of the present invention. The tensioning apparatus includes a tensioning device 1 and a reeling device 2. The tensioning device 1 includes a frame 10, a tensioning mechanism 20 rotatably mounted on the frame 10, and a lever 30 including a first end connected with the tensioning mechanism 20. The lever 30 also includes a second end with a gripping portion 31. Generally, user holds on the gripping portion 31 to operate the lever 30. The lever 30 can be reciprocally pivoted to rotate the tensioning mechanism 20.

The tensioning mechanism 20 can tension a strap 60 as it is rotated. The strap 60 includes first and second portions extending in opposite directions of the tensioning mechanism 20. In this embodiment, one of the first and second portions is adapted to be collected on the reeling device 2.

The frame 10 extends from a first end 101 to a second end 102 and defines a longitudinal length. The tensioning mechanism 20 is disposed on the first end 101, while the reeling device 2 is disposed on the second end 102. The reeling device 2 is disposed far enough from the tensioning mechanism 20 so that the operation of the lever 30 would not be interfered by the strap 60 on the reeling device 2, as discussed in the Description of the Related Prior Art. Additionally, the lever 30 has a longitudinal length slightly longer than that of the frame 10.

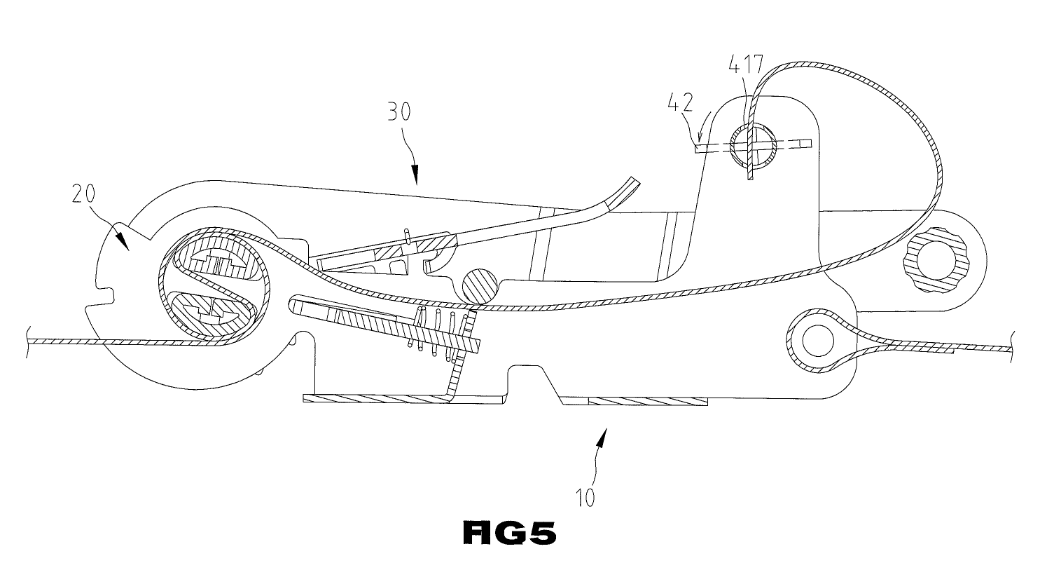

The reeling device 2 includes a reel mechanism 40 and a ratcheting mechanism 50. The reel mechanism 40 includes a shaft 41 having a first end 411 connected with a first lateral wall 11 of the frame 10 and a second end 412 connected with a second lateral wall 12 of the frame 10, respectively. The first and second lateral walls 11 and 12 are spaced from each other. Additionally, the first lateral wall 11 includes a first receiving hole 131 extended therethrough and the second lateral wall 12 includes a second receiving hole 132 extended therethrough, respectively. The shaft 41 extends through the first and second receiving holes 131 and 132. User can operably rotate the shaft 41. Additionally, the shaft 41 may includes a handle 42 mounted thereon for facilitating user to rotate the shaft 41. Further, the shaft 41 includes a slot 415 formed on the first end 411 thereof for receiving the handle 42. Further, the shaft 41 includes a first aperture 413, and the handle 42 includes a second aperture 421, and a fastener 414 is utilized to insert through the first aperture 413 and the second aperture 421 so as to secure the handle 42 on the shaft 41. Furthermore, the shaft 41 may include a through-slot 417 for facilitating attachment of the strap 60 with the shaft 41, as shown in FIG. 5.

The second end 412 of the shaft 41 defines an engaging section 416 for engaging with a ratchet member 51 of the ratcheting mechanism 50. The ratchet member 51 includes a plurality of teeth and is rotated with the shaft 41 as the shaft 41 is rotated. The ratcheting mechanism 50 also includes a pawl 52 having an engaging end 521 engaged with the ratchet member 51. The pawl 52 is attached to the second lateral wall 12 of the frame 10 by a fastener 53. The fastener 53 is inserted through the pawl 52, a spacer 55 and engaged in an orifice 14 defined on the second lateral wall 12. Further, an elastic member 54 includes a plurality of loops and first and second legs 541 and 542. The first leg 541 is engaged in an aperture 15 formed in the second lateral wall 12, and the second leg 542 is engaged in a hole 522 formed in the pawl 52, respectively. The elastic member 54 enables the pawl 52 to be biasably moved to engage the rotated ratchet member 51.

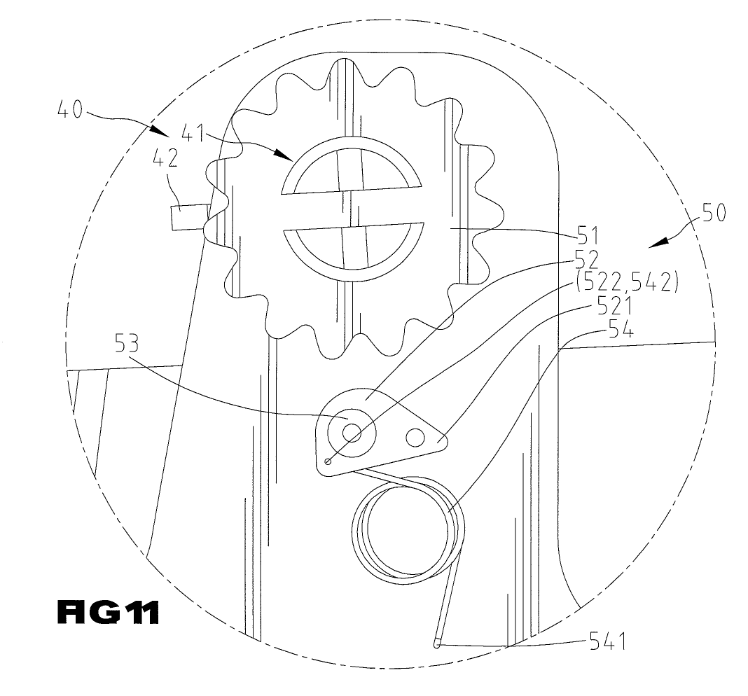

Further, FIG. 11 shows that the pawl 52 is adapted to be retained at a position and disengaged from the ratchet member 51. Under this circumstance, user can unreel the strap 60 collected on the reeling device 2.

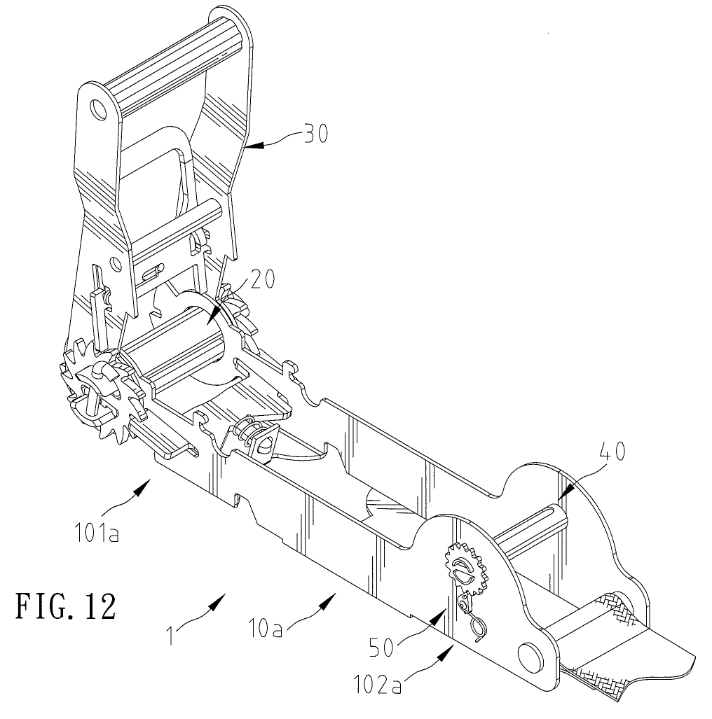

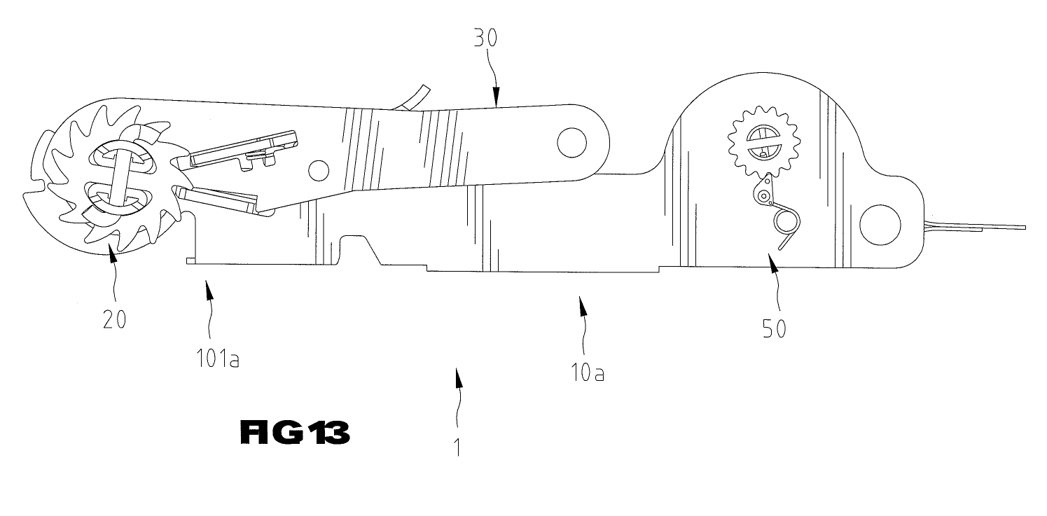

FIGS. 12 and 13 show a tensioning apparatus in accordance with a second embodiment of the present invention. This embodiment differentiates from the first embodiment in that it includes a frame 10a extending from a first end 101a to a second end 102a. The frame 10a is more extended than the frame 10 and defines a longitudinal length longer than that of the frame 10. Additionally, the longitudinal length of the lever 30 is shorter than that of the frame 10a.

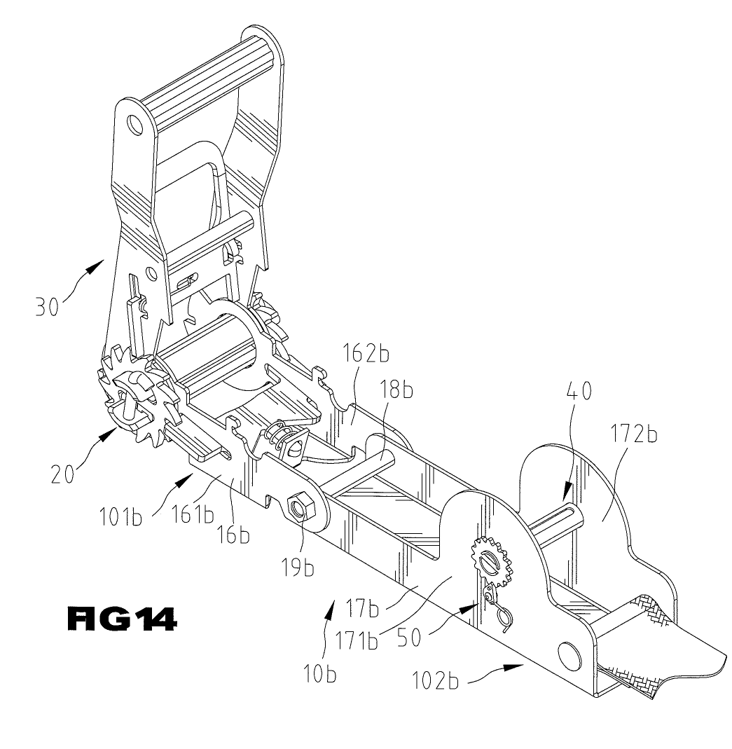

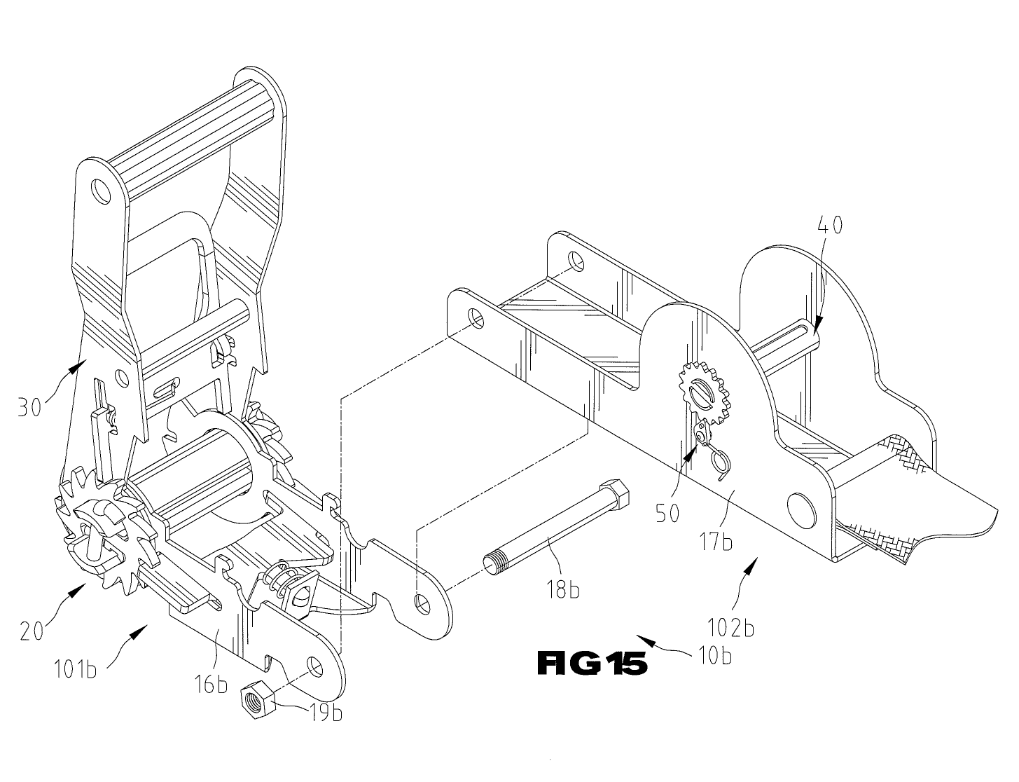

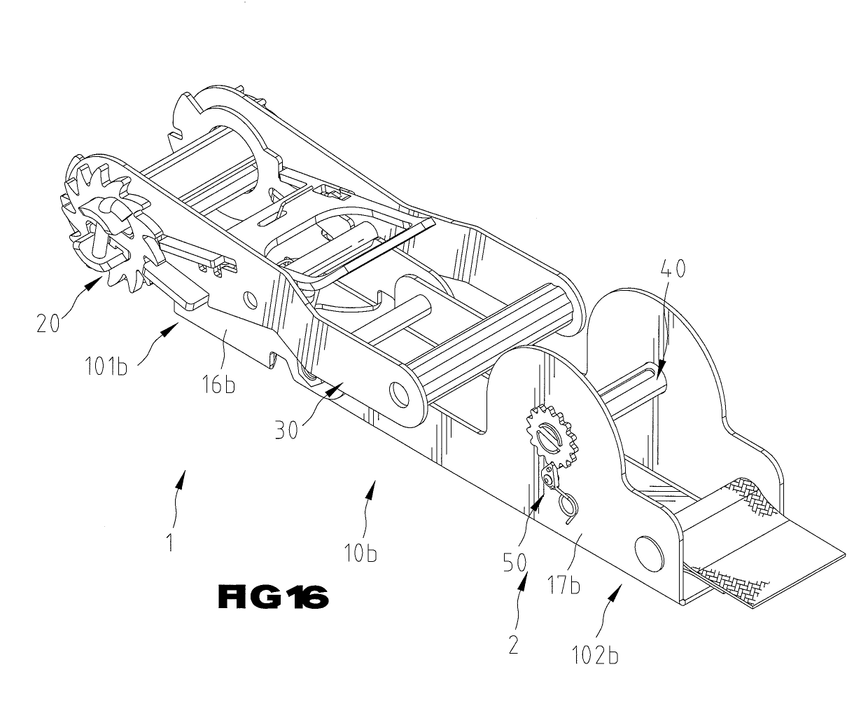

FIGS. 14 through 16 show a tensioning apparatus in accordance with a third embodiment of the present invention. This embodiment differentiates from the first embodiment in that it includes a frame 10b including a first frame section 16b and a second frame section 17b releasably connected with the first frame section 16b. The frame 10b includes a first end 101b defined on the first frame section 16b and a second end 102b defined on the second frame section 17b. The first frame section 16b includes first and second lateral edges 161b and 162b opposed to each other, whereas the second frame section 17b includes first and second lateral edges 171b and 172b opposed to each other. The tensioning mechanism 20 and the lever 30 are mounted on the first frame section 16b, whereas the reel mechanism 40 and the ratcheting mechanism 50 are mounted on the second frame section 17b. Further, an axle 18b is inserted through the lateral walls of the first and second frame sections 16b and 17b so as to connect the first and second frame sections 16b and 17b together. Additionally, the axle 18b may be coupled with a stopper 19b, and the stopper 19b prevents the axle 18b disengaged from the first and second frame sections 16b and 17b. Further, the frame 10b is more extended than the frame 10 and defines a longitudinal length longer than that of the frame 10. Additionally, the longitudinal length of the lever 30 is shorter than that of the frame 10b.

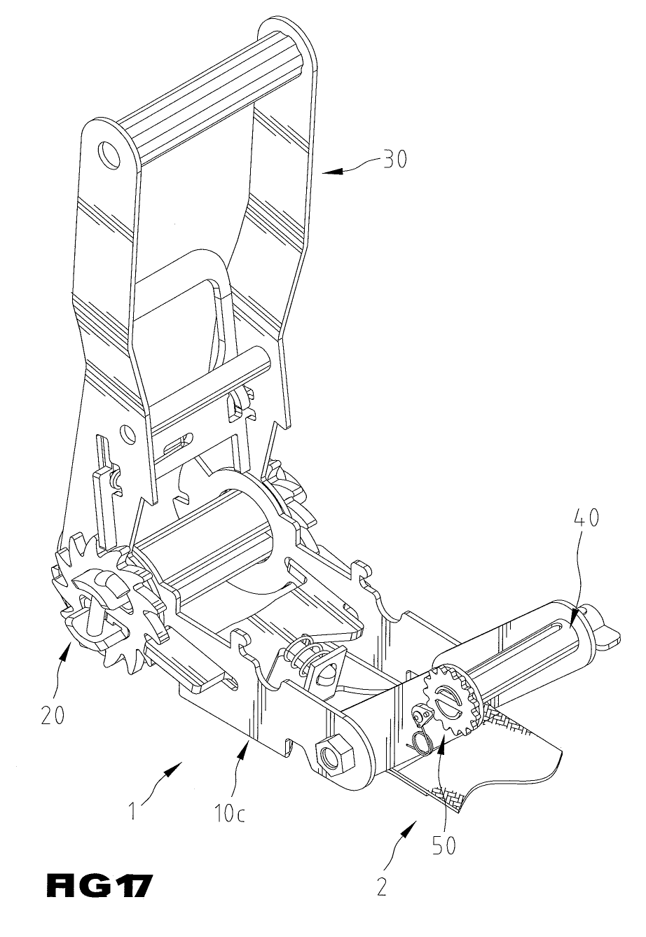

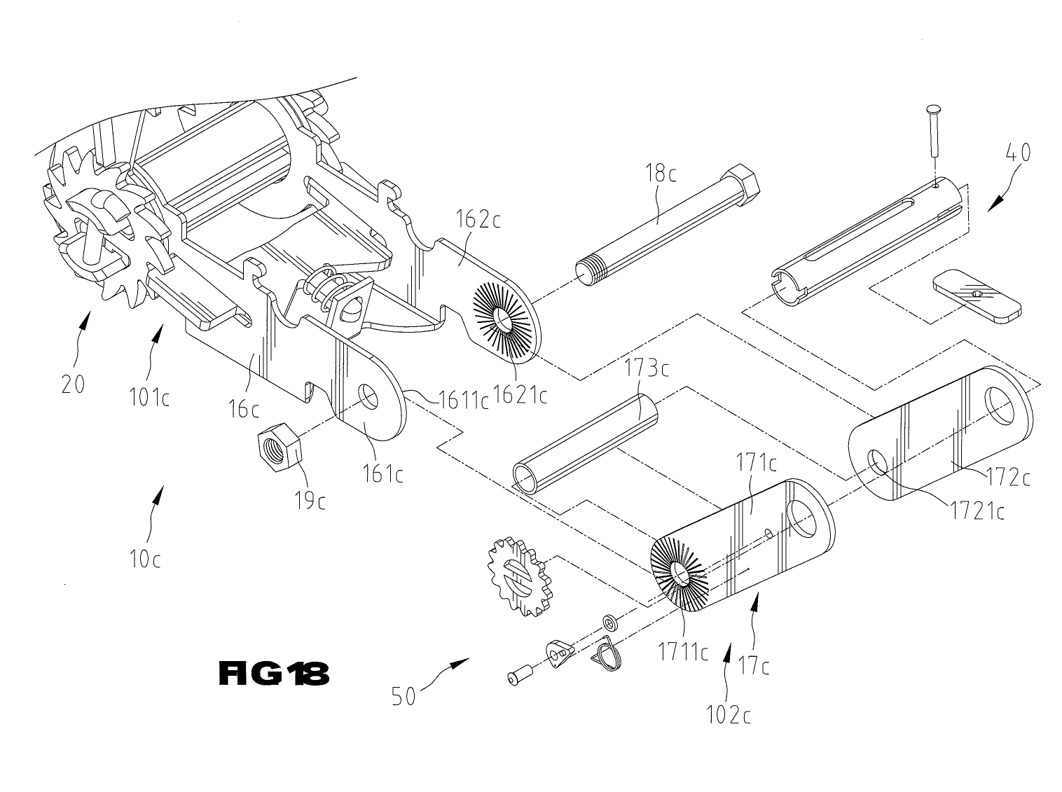

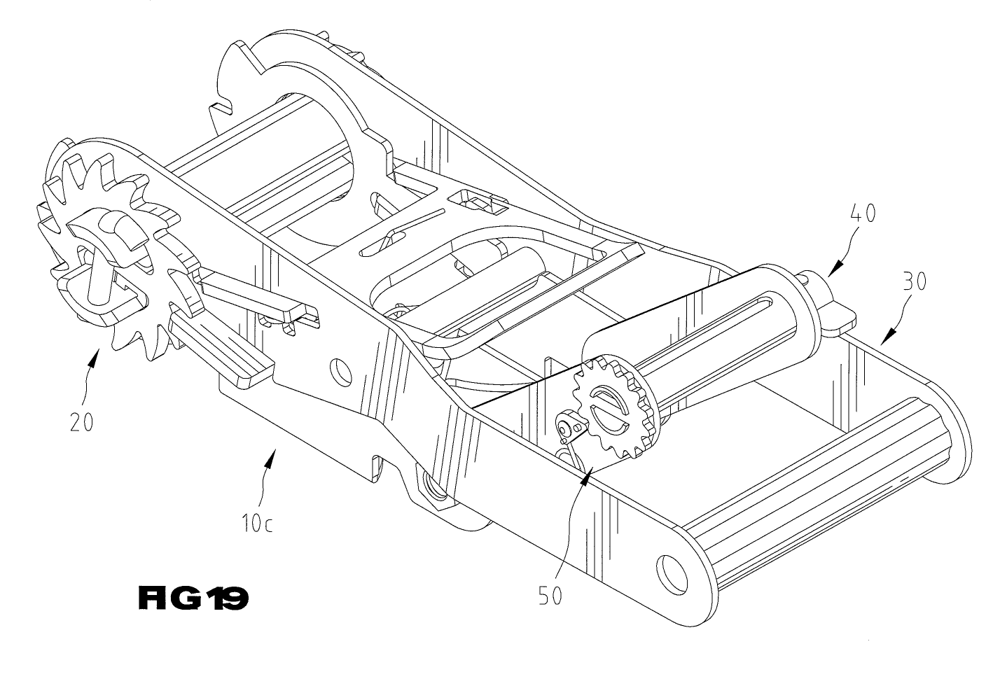

FIGS. 17 through 19 show a tensioning apparatus in accordance with a fourth embodiment of the present invention. This embodiment differentiates from the first embodiment in that it includes a frame 10c including a first frame section 16c and a second frame section 17c releasably connected with the first frame section 16c. The frame 10c includes a first end 101c defined on the first frame section 16c and a second end 102c defined on the second frame section 17c. The tensioning mechanism 20 and the lever 30 are mounted on the first frame section 16c, whereas the reel mechanism 40 and the ratcheting mechanism 50 are mounted on the second frame section 17c.

The first frame section 16c includes a first lateral edge 161c and a second lateral edge 162c spaced from the first lateral edge 161c. The first lateral edge 161c includes a side formed with a first retaining section 1611c, and the second lateral edge 162c includes a side formed with a second retaining section 1621c, respectively. The first and second retaining sections 1611c and 1621c are of the same configuration and are opposed to each other. In this embodiment, the configuration includes a plurality of radially disposed patterns.

The second frame section 17c includes first and second mounting members 171c and 172c of the same configuration and separated and existed distinctively from each other. It is an aspect that the first and second mounting members 171c and 172c have configurations that save use of material and weight of the tensioning apparatus. The first mounting member 171c includes a first end having a third retaining section 1711c engaged with the first retaining section 1611c, and the second mounting member 172c includes a first end having a fourth retaining section 1721c engaged with the second retaining section 1621c, respectively. Thus, the first and second mounting members 171c and 172c are adapted to be retained at an angled position securely. Further, the first retaining section 1611c is a male configuration, while the third retaining section 1711c is a female configuration, or otherwise. Likewise, the second retaining section 1621c is a male configuration, while the fourth retaining section 1721c is a female configuration, or otherwise. Further, a sleeve 173c is disposed between the first ends of the first and second mounting members 171c and 172c, and an axle 18c is inserted from one of the first and second lateral edges 161c and 162c, the first end of one of the first and second mounting members 171c and 172c, the sleeve 173c, the first end of the other of the first and second mounting members 171c and 172c, and the other of the first and second lateral edges 161c and 162c so as to connect the first and second frame sections 16c and 17c together. Further, the reel mechanism 40 is disposed between second ends of the first and second mounting members 171c and 172c, and the ratcheting mechanism 50 is disposed on one of the first and second mounting members 171c and 172c.

In addition, the axle 18c may be coupled with a stopper 19c, and the stopper 19c prevents the axle 18c disengaged from the first and second frame sections 16c and 17c. Further, the frame 10c is more extended than the frame 10 and defines a longitudinal length longer than that of the frame 10. Additionally, the longitudinal length of the lever 30 is shorter than that of the frame 10c.

It is an object of the present invention that the reeling device 2 is used for collecting one of the first and second portions of the strap 60.

It is another object of the present invention that the strap 60 on the reeling device 2 will not obstruct the operation of the lever 30.

It is a further object of the present invention that the ratcheting mechanism 50 facilitates collection of the second portion of the strap 60 by preventing the shaft 41 from turning in a direction to unreel the strap 60.

While the specific embodiments have been illustrated and described, numerous modifications come to mind without significantly departing from the spirit of invention and the scope of invention is only limited by the scope of accompanying claims.

What is claimed is:

1. A tensioning apparatus comprising:
a frame including a first end and a second end and defining a longitudinal length from the first end to the second end;
a tensioning mechanism rotatably mounted on the first end of the frame;
a lever connected with the tensioning mechanism and operably pivoted with respect to the frame to rotate the tensioning mechanism;
a reel mechanism mounted on the second end of the frame and including a shaft rotatably mounted on the frame;
a ratcheting mechanism including a ratchet member mounted on the shaft and rotated with the shaft, a pawl, and an elastic element biasably urging the pawl to engaged with the ratchet member; and
wherein the reeling mechanism and the ratcheting mechanism are disposed far enough so as not to interfere the operation of the lever; and
wherein engagement between the ratchet member and the pawl provides a step-by-step effect and facilitates collection of a strap on the shaft by preventing the shaft from turning in a direction to unreel the strap.

2. The tensioning apparatus as claimed in claim 1 wherein the lever has a first longitudinal length slightly longer than the longitudinal length of the frame.

3. The tensioning apparatus as claimed in claim 1 wherein the lever has a first longitudinal length shorter than the longitudinal length of the frame.

4. The tensioning apparatus as claimed in claim 1 wherein the frame includes a first frame section and a second frame section releasably connected with the first frame section, with the tensioning mechanism and the lever mounted on the first frame section, with the reel mechanism and the ratcheting mechanism mounted on the second frame section.

5. The tensioning apparatus as claimed in claim 4 wherein the first frame section includes a first lateral edge including a side formed with a first retaining section and a second lateral edge including a side formed with a second retaining section respectively, with the first and second retaining sections are of the same configuration and are opposed to each other, wherein the second frame section includes a first mounting member including a first end having a third retaining section engaged with the first retaining section and a second mounting member including a first end having a fourth retaining section engaged with the second retaining section respectively.

6. The tensioning apparatus as claimed in claim 5 wherein the first and second mounting members are of the same configuration and are separated and existed distinctively from each other.

7. The tensioning apparatus as claimed in claim 4 further comprising an axle inserted through the first and second frame sections so as to connect the first and second frame sections together.

8. The tensioning apparatus as claimed in claim 7 wherein the axle is coupled with a stopper at an end thereof to prevent the axle disengaged from the first and second frame sections.

9. The tensioning apparatus as claimed in claim 5 wherein one of the first and third retaining sections is a male configuration and the other of the first and third retaining section is a female configuration, and wherein one of the second and fourth retaining section is a male configuration and the other of the second and fourth retaining sections is a female configuration.

10. The tensioning apparatus as claimed in claim 6 wherein one of the first and third retaining sections is a male configuration and the other of the first and third retaining section is a female configuration, and wherein one of the second and fourth retaining section is a male configuration and the other of the second and fourth retaining sections is a female configuration.

11. The tensioning apparatus as claimed in claim 7 wherein the second frame section includes a sleeve, with the axle inserted through the sleeve and the first and second frame sections.

12. The tensioning apparatus as claimed in claim 1 wherein the pawl is operably moveable between a first position in engagement with the ratchet member and a second position disengaged from the ratchet member, and wherein the strap collected on the reel mechanism is adapted to be unreeled.

13. The tensioning apparatus as claimed in claim 1 wherein the ratchet member includes a plurality of teeth, and wherein the pawl is engaged in a space between two of the plurality of teeth of the ratchet member and the pawl is disengaged from the space and biasably urged to engage in another space by the elastic element during rotation of the ratchet member.

14. The tensioning apparatus as claimed in claim 1 wherein the elastic member includes first and second legs, with the first leg engaged in the frame and the second leg engaged in the pawl respectively, and wherein the elastic member enables the pawl to be biasably moved to engage the rotated ratchet member.

15. The tensioning apparatus as claimed in claim 14 wherein the elastic member includes a plurality of loops.
